(19) United States
(12) Patent Application Publication
(10) Pub. No.: US 2025/0191330 A1
(43) Pub. Date: Jun. 12, 2025

(54) DOMAIN ADAPTATION VIA NETWORK CALIBRATION

(71) Applicant: Cisco Technology, Inc., San Jose, CA (US)

(72) Inventors: Gaowen Liu, Austin, TX (US); Ramana Rao V. R. KOMPELLA, Foster City, CA (US)

(21) Appl. No.: 18/531,826

(22) Filed: Dec. 7, 2023

(51) Int. Cl. G06V 10/44; G06V 10/60; G06V 10/764

(52) U.S. Cl. CPC G06V 10/44; G06V 10/60; G06V 10/764; G06V 2201/07

(57) ABSTRACT

In one implementation, a device receives, via a user interface, a selection of a machine learning model trained to perform a video analytics task using a training dataset. The device obtains video data from a target environment that is not represented in the training dataset. The device performs, using the video data, network calibration on the machine learning model to form a domain-adapted model. The device causes the domain-adapted model to be deployed to perform the video analytics task with respect to the target environment.

### TECHNICAL FIELD

The present disclosure relates generally to domain adaptation via network calibration.

### BACKGROUND

With the advents of machine and deep learning, video analytics systems have grown in both their capabilities, as well as their complexities. One use for such systems exists in the context of multi-camera surveillance systems, to detect people and other objects and make decisions about their behaviors. For instance, a surveillance system in an airport or other sensitive area may seek to detect when a person leaves an object unattended. Example tasks in the realm of video analytics include, but are not limited to, classification tasks, re-identification tasks, and object detection tasks.

In computer vision, domain shift refers to a situation where there is a difference or mismatch between the distribution of data used to train a model and the distribution of data encountered during its deployment or testing in real-world scenarios. This shift can occur due to variations in image properties, such as lighting conditions, camera perspectives, object appearances, or environmental factors.

Domain shift poses a challenge because the model may not generalize well to unseen data from the target domain if it has only been trained on a different source domain. The performance of a computer vision model can significantly degrade when faced with a domain shift, leading to decreased model accuracy and reliability in real-world situations.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrate an example network;

FIG. 2 illustrates an example network device/node;

FIG. 3 illustrates an example system for performing video analytics;

FIG. 4 illustrates an example architecture for domain adaptation via network calibration;

FIGS. 5A-5B illustrate examples of calibrating a model using data from a target domain;

FIG. 6 illustrates an example of calibrating a model for different target domains;

FIG. 7 illustrates an example user interface for performing domain adaptation; and

FIG. 8 illustrates an example simplified procedure for domain adaptation via network calibration.

### DESCRIPTION OF EXAMPLE IMPLEMENTATIONS

### Overview

According to one or more implementations of the disclosure, a device receives, via a user interface, a selection of a machine learning model trained to perform a video analytics task using a training dataset. The device obtains video data from a target environment that is not represented in the training dataset. The device performs, using the video data, network calibration on the machine learning model to form a domain-adapted model. The device causes the domain-adapted model to be deployed to perform the video analytics task with respect to the target environment.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. Other types of networks, such as field area networks (FANs), neighborhood area networks (NANs), personal area networks (PANs), etc. may also make up the components of any given computer network.

In various implementations, computer networks may include an Internet of Things network. Loosely, the term “Internet of Things” or “IoT” (or “Internet of Everything” or “IoE”) refers to uniquely identifiable objects (things) and their virtual representations in a network-based architecture. In particular, the IoT involves the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Often, IoT networks operate within a shared-media mesh networks, such as wireless or wired networks, etc., and are often on what is referred to as Low-Power and Lossy Networks (LLNs), which are a class of network in which both the routers and their interconnect are constrained. That is, LLN devices/routers typically operate with constraints, e.g., processing power, memory, and/or energy (battery), and their interconnects are characterized by, illustratively, high loss rates, low data rates, and/or instability. IoT networks are comprised of anything from a few dozen to thousands or even millions of devices, and support point-to-point traffic (between devices inside the network), point-to-multipoint traffic (from a central control point such as a root node to a subset of devices inside the network), and multipoint-to-point traffic (from devices inside the network towards a central control point).

Edge computing, also sometimes referred to as “fog” computing, is a distributed approach of cloud implementation that acts as an intermediate layer from local networks (e.g., IoT networks) to the cloud (e.g., centralized and/or shared resources, as will be understood by those skilled in the art). That is, generally, edge computing entails using devices at the network edge to provide application services, including computation, networking, and storage, to the local nodes in the network, in contrast to cloud-based approaches that rely on remote data centers/cloud environments for the services. To this end, an edge node is a functional node that is deployed close to IoT endpoints to provide computing, storage, and networking resources and services. Multiple edge nodes organized or configured together form an edge compute system, to implement a particular solution. Edge nodes and edge systems can have the same or complementary capabilities, in various implementations. That is, each individual edge node does not have to implement the entire spectrum of capabilities. Instead, the edge capabilities may be distributed across multiple edge nodes and systems, which may collaborate to help each other to provide the desired services. In other words, an edge system can include any number of virtualized services and/or data stores that are spread across the distributed edge nodes. This may include a master-slave configuration, publish-subscribe configuration, or peer-to-peer configuration.

Low power and Lossy Networks (LLNs), e.g., certain sensor networks, may be used in a myriad of applications such as for “Smart Grid” and “Smart Cities.” A number of challenges in LLNs have been presented, such as:
1) Links are generally lossy, such that a Packet Delivery Rate/Ratio (PDR) can dramatically vary due to various sources of interferences, e.g., considerably affecting the bit error rate (BER);
2) Links are generally low bandwidth, such that control plane traffic must generally be bounded and negligible compared to the low rate data traffic;
3) There are a number of use cases that require specifying a set of link and node metrics, some of them being dynamic, thus requiring specific smoothing functions to avoid routing instability, considerably draining bandwidth and energy;
4) Constraint-routing may be required by some applications, e.g., to establish routing paths that will avoid non-encrypted links, nodes running low on energy, etc.;
5) Scale of the networks may become very large, e.g., on the order of several thousands to millions of nodes; and
6) Nodes may be constrained with a low memory, a reduced processing capability, a low power supply (e.g., battery).

In other words, LLNs are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example implementation of LLNs is an “Internet of Things” network. Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid advanced metering infrastructure (AMI), smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

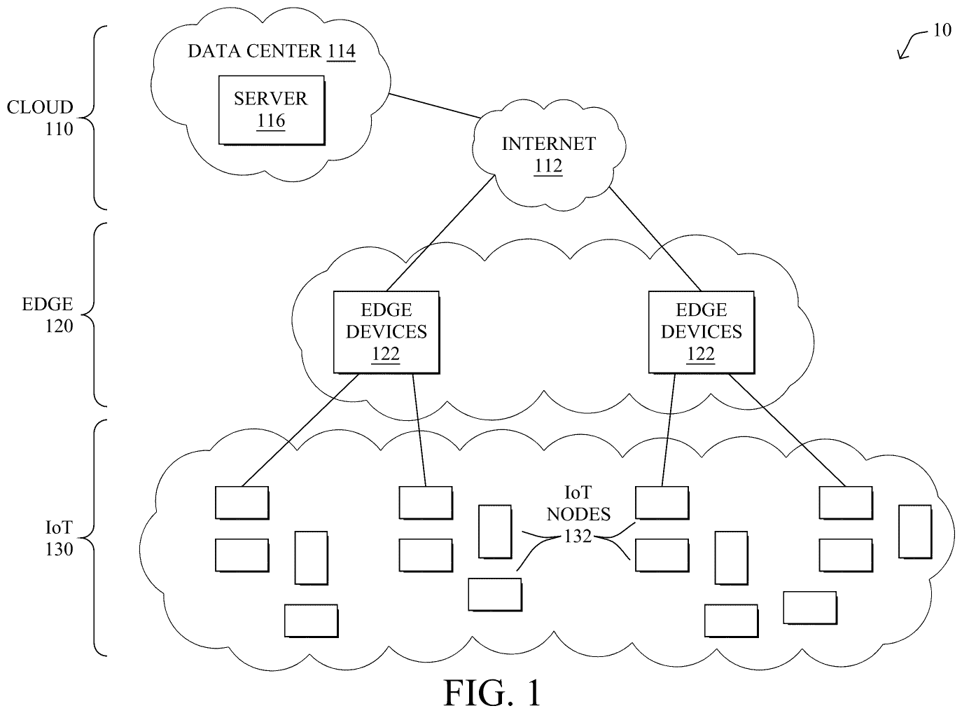

FIG. 1 is a schematic block diagram of an example simplified computer network 100 illustratively comprising nodes/devices at various levels of the network, interconnected by various methods of communication. For instance, the links may be wired links or shared media (e.g., wireless links, wired links, etc.) where certain nodes, such as, e.g., routers, sensors, computers, etc., may be in communication with other devices, e.g., based on connectivity, distance, signal strength, current operational status, location, etc.

Specifically, as shown in the example IoT network 100, three illustrative layers are shown, namely cloud layer 110, edge layer 120, and IoT device layer 130. Illustratively, the cloud layer 110 may comprise general connectivity via the Internet 112, and may contain one or more datacenters 114 with one or more centralized servers 116 or other devices, as will be appreciated by those skilled in the art. Within the edge layer 120, various edge devices 122 may perform various data processing functions locally, as opposed to datacenter/cloud-based servers or on the endpoint IoT nodes 132 themselves of IoT device layer 130. For example, edge devices 122 may include edge routers and/or other networking devices that provide connectivity between cloud layer 110 and IoT device layer 130. Data packets (e.g., traffic and/or messages sent between the devices/nodes) may be exchanged among the nodes/devices of the computer network 100 using predefined network communication protocols such as certain known wired protocols, wireless protocols, or other shared-media protocols where appropriate. In this context, a protocol consists of a set of rules defining how the nodes interact with each other.

Those skilled in the art will understand that any number of nodes, devices, links, etc. may be used in the computer network, and that the view shown herein is for simplicity. Also, those skilled in the art will further understand that while the network is shown in a certain orientation, the network 100 is merely an example illustration that is not meant to limit the disclosure.

Data packets (e.g., traffic and/or messages) may be exchanged among the nodes/devices of the computer network 100 using predefined network communication protocols such as certain known wired protocols, wireless protocols (e.g., IEEE Std. 802.15.4, Wi-Fi, Bluetooth®, DECT-Ultra Low Energy, LoRa, etc. . . . ), or other shared-media protocols where appropriate. In this context, a protocol consists of a set of rules defining how the nodes interact with each other.

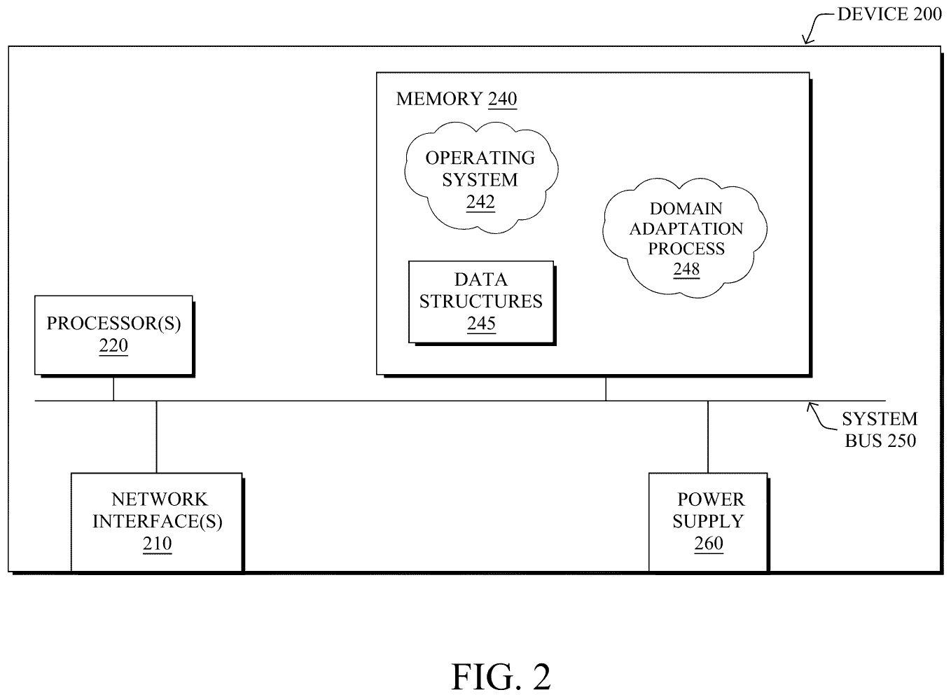

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more network interfaces 210 (e.g., wired, wireless, etc.), at least one processor 220, and a memory 240 interconnected by a system bus 250, as well as a power supply 260 (e.g., battery, plug-in, etc.).

Network interface(s) 210 include the mechanical, electrical, and signaling circuitry for communicating data over links coupled to the network. The network interfaces 210 may be configured to transmit and/or receive data using a variety of different communication protocols, such as TCP/IP, UDP, etc. Note that the device 200 may have multiple different types of network connections, e.g., wireless and wired/physical connections, and that the view herein is merely for illustration.

The memory 240 comprises a plurality of storage locations that are addressable by the processor 220 and the network interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes/services may comprise an illustrative domain adaptation process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

In various implementations, domain adaptation process 248 employ one or more supervised, unsupervised, or semi-supervised machine learning models. Generally, supervised learning entails the use of a training set of data, as noted above, that is used to train the model to apply labels to the input data. For example, the training data may include sample images or other video data that depict certain types of objects or behaviors and are labeled as such. On the other end of the spectrum are unsupervised techniques that do not require a training set of labels. Notably, while a supervised learning model may look for previously seen patterns that have been labeled, an unsupervised model may instead look to whether there are sudden changes in the behavior. Semi-supervised learning models take a middle ground approach that uses a greatly reduced set of labeled training data.

Example machine learning techniques that domain adaptation process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) ANNs (e.g., for non-linear models), replicating reservoir networks (e.g., for non-linear models, typically for time series), random forest classification, or the like.

In further embodiments, domain adaptation process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, process 248 may use a generative model to generate synthetic network traffic based on existing user traffic to test how the network reacts. Example generative approaches can include, but are not limited to, generative adversarial networks (GANs), large language models (LLMs), other transformer models, and the like.

The performance of a machine learning model can be evaluated in a number of ways based on the number of true positives, false positives, true negatives, and/or false negatives of the model. For example, the false positives of the model may refer to the number of times the model incorrectly detected a particular type of object in a video. Conversely, the false negatives of the model may refer to the number of times the model failed to detect that type of object in the video. True negatives and positives may refer to the number of times the model correctly performed its video analytics task, either in the negative or positive sense (e.g., correctly determining that the object type was not present in the video or was present). Thus, the accuracy of the model may correspond to the ratio of true positives to total assessments made by the model. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

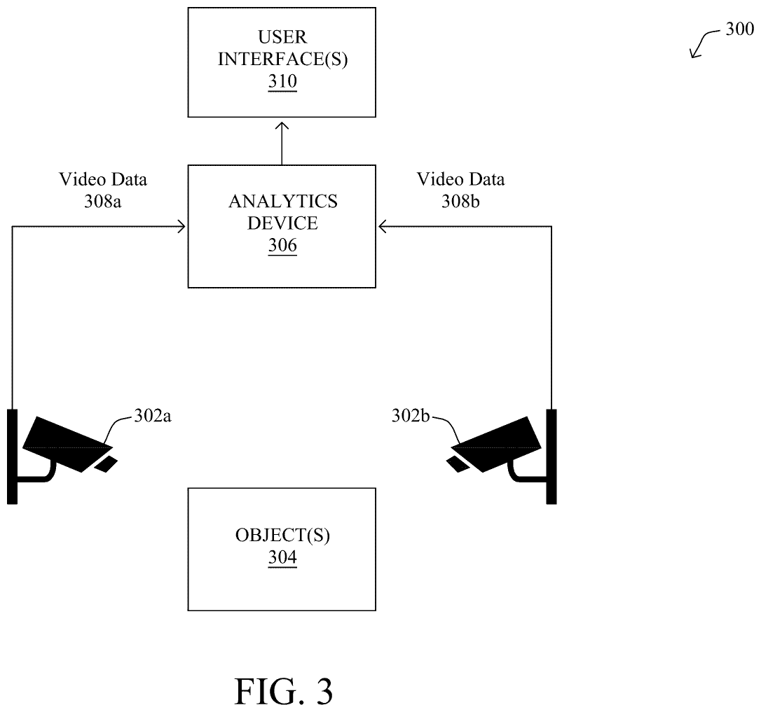

FIG. 3 illustrates an example system 300 for performing video analytics, as described in greater detail above. As shown, there may be any number of cameras 302 deployed to a physical area, such as cameras 302a-302b. Such surveillance is now fairly ubiquitous across various locations including, but not limited to, public transportation facilities (e.g., train stations, bus stations, airports, etc.), entertainment facilities (e.g., sports arenas, casinos, theaters, etc.), schools, office buildings, and the like. In addition, so-called “smart” cities are also now deploying surveillance systems for purposes of monitoring vehicular traffic, crime, and other public safety events.

Regardless of the deployment location, cameras 302a-302b may generate and send video data 308a-308b, respectively, to an analytics device 306 (e.g., a device executing a machine learning model trained to perform a video analytics task). For instance, analytics device 306 may be an edge device (e.g., an edge device 122 in FIG. 1), a remote server (e.g., a server 116 in FIG. 1), or may even take the form of a particular endpoint in the network, such as a dedicated analytics device, a particular camera 302, or the lie.

In general, analytics device 306 may be configured to provide video data 308a-308b for display to one or more user interfaces 310, as well as to analyze the video data for events that may be of interest to a potential user. To this end, analytics device 306 may perform a video analytics task or set of tasks on video data 308a-308b. For instance, such video analytics tasks may include any or all of the following:
Image classification—i.e., recognizing what a particular image represents
Re-identification—i.e., recognizing that a depicted object is the same across different portions of video and/or video feeds (e.g., a person walks around a corner, transitioning from the video feed of one camera to another)
Object detection—i.e., detecting the presence of certain types of objects in the video (e.g., vehicles, people, etc.)
Etc.

As noted above, though, video analytics systems that rely on artificial intelligence/machine learning are often subject to domain shift, whereby there is a difference or mismatch between the distribution of data used to train a model and the distribution of data encountered during its deployment or testing in real-world scenarios. This shift can occur due to variations in image properties, such as lighting conditions, camera perspectives, object appearances, environmental factors, or the like. Consequently, the performance of the model once deployed will be degraded. Indeed, domain shift poses a challenge because the model may not generalize well to unseen data from the target domain/deployment environment, if it has only been trained on a different source domain.

### Domain Adaptation Via Network Calibration

The techniques introduced herein provide for a training-free, domain adaptation approach. In some aspects, the techniques herein rely on model calibration to adjust the model to the conditions of the target domain.

Illustratively, the techniques described herein may be performed by hardware, software, and/or firmware, such as in accordance with the domain adaptation process 248, which may include computer executable instructions executed by the processor 220 (or independent processor of interfaces 210), to perform functions relating to the techniques described herein.

Specifically, according to various implementations, a device receives, via a user interface, a selection of a machine learning model trained to perform a video analytics task using a training dataset. The device obtains video data from a target environment that is not represented in the training dataset. The device performs, using the video data, network calibration on the machine learning model to form a domain-adapted model. The device causes the domain-adapted model to be deployed to perform the video analytics task with respect to the target environment.

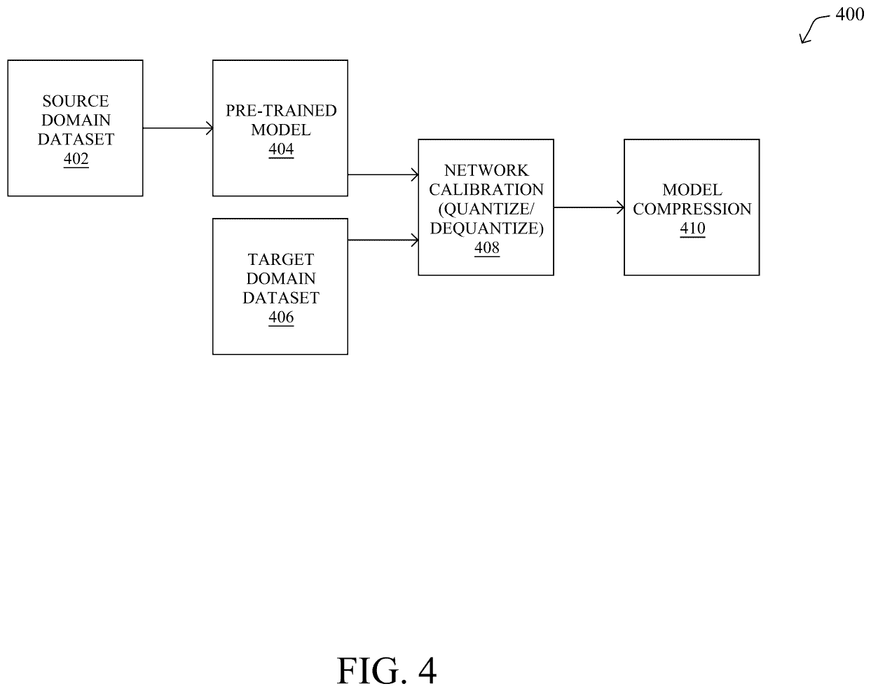

Operationally, in various implementations, FIG. 4 illustrates an example architecture 400 for domain adaptation via network calibration, in various implementations. As shown, domain adaptation process 248 may include and/or process any or all of the following components: a source domain dataset 402, a pre-trained model 404, a target domain dataset 406, a network calibration engine 408, and a model compression module 410. As would be appreciated, these components may be combined or omitted as desired. In addition, these components may be executed in a distributed manner across multiple devices, in which case the combination of executing devices may be viewed as a singular device for purposes of the teachings herein.

As an initial step, domain adaptation process 248 may obtain pre-trained model 404 either by training it directly or from another source. In general, pre-trained model 404 may be configured to perform one or more video analytics tasks such as any or all of the following: image classification, object detection, object re-identification, or any other form of machine learning-based video analytics. In various implementations, pre-trained model 404 may be trained using source domain dataset 402 from one or more source environments (e.g., buildings, streets, waterways, airports, etc.). Typically, source domain dataset 402 will include video or image data captured in the one or more source domains/environments.

Here, the one or more source domains/environments differ from that of the target domain/environment for which a video analytics model is to be used. Due to the potential for domain shift between source domain dataset 402 and the video data from the target domain/environment, pre-trained model 404 may not perform well with respect to the target domain/environment. Accordingly, the techniques herein propose adapting pre-trained model 404 for use to assess video from the target domain/environment using network calibration engine 408 and target domain dataset 406, which may include video, image, and/or other data from the target environment for which the model is to be used.

In various implementations, network calibration engine 408 may be configured to perform network calibration on a neural network, such as pre-trained model 404. Generally, network calibration entails ensuring the accuracy of the probabilities associated with any classifications or other video analytics tasks performed by the model. Typically, though, this is done with respect to data from the source domain/environment for which the training data from the model was sourced. Here, network calibration engine 408 may instead perform calibration of pre-trained model 404 using target domain dataset 406 by performing quantization or de-quantization based on the differences between source domain dataset 402 and target domain dataset 406.

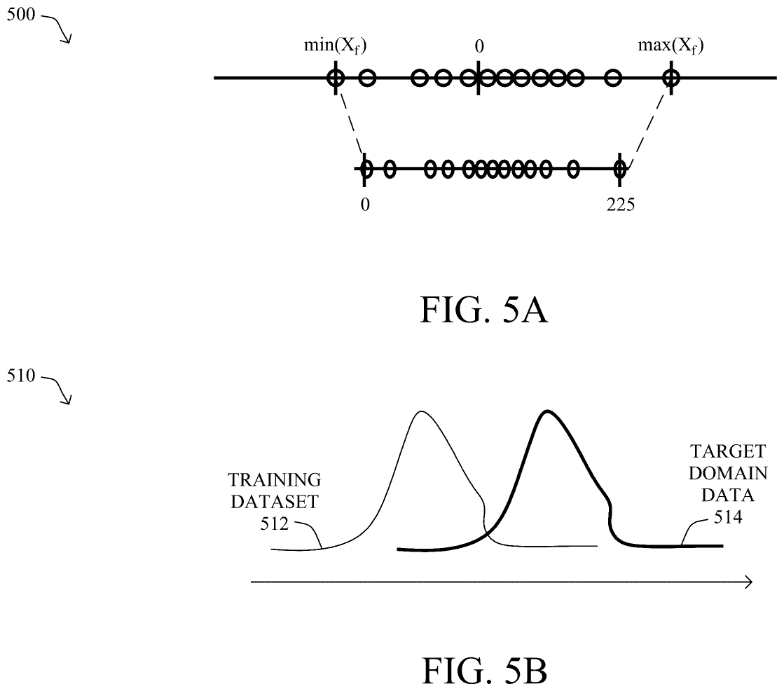

More specifically, FIGS. 5A-5B illustrate examples of calibrating a model using data from a target domain. As shown in example 500 in FIG. 5A, quantization typically entails converting a machine learning model (e.g., pre-trained model 404) from using higher precision tensors (e.g., ones with floating point values) into one that uses reduced precision tensors (e.g., ones that use integer values). Doing so can greatly increase the processing times of the model. For instance, as shown, assume that the original tensors have floating point values (x_{f}) ranging from min (x_{f}) to max (x_{f}), which may be mapped during the quantization into integer values ranging from 0 to 255, −128 to 127, etc.

As would be appreciated, quantization can be either symmetric or affine/asymmetric. In symmetric quantization, the zero-point is zero (e.g., 0.0 in the floating point range is the same as zero in the quantized range). In affine/asymmetric quantization, the zero-point is a non-zero value in the quantized range. Thus, there are two parameters needed to perform quantization: the zero point value and a scaling factor. For example, network calibration engine 408 may perform quantization as follows:

$${x}_{q} = round ( ( {x}_{f} - {min}_{{x}_{f}} ) \frac{{2}^{n} - 1}{\underbrace{{max}_{{x}_{f}} - {min}_{{x}_{f}}}_{{q}_{x}}} ) = round ( {q}_{x} {x}_{f} - \underbrace{{min}_{{x}_{f}} {q}_{x}}_{{zp}_{x}} ) = round ( {q}_{x} {x}_{f} - {zp}_{x} )$$

In various implementations, network calibration engine 408 may compute the difference between the distributions of source domain dataset 402 and target domain dataset 406. For instance, as shown in example 510 in FIG. 5B, there may be a difference between the distribution 512 of source domain dataset 402 and distribution 514 of target domain dataset 406. Based on this difference, network calibration engine 408 may compute a new minimum, maximum, and zero point value, in order to drive the parameters for the quantization of pre-trained model 404.

Optionally, once network calibration engine 408 has calibrated pre-trained model 404 to adapt it to the target domain/environment, it may pass the resulting model to model compression module 410, which compresses that model prior to deployment. Such compression may take the form of specializing the model for specific situations expected in the target domain/environment, pruning the model, etc.

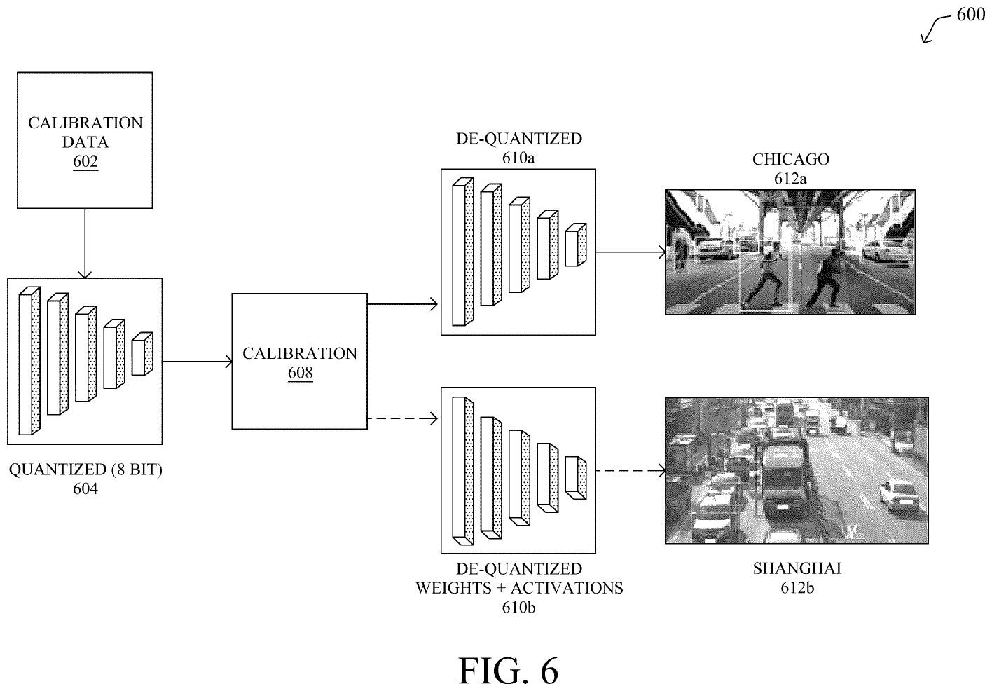

FIG. 6 illustrates an example 600 of calibrating a model for different target domains, in various implementations. As shown, assume that calibration data 602 is available to network calibration engine 408. In turn, network calibration engine 408 may perform quantization on calibration data 602, to generate a quantized dataset 604 (e.g., in 8-bit integer form). From there, it may perform calibration 608, thereby adjusting the weights and activations of the model as needed, to adjust it to the target domain(s)/environment(s). For instance, in some cases, the system may perform dequantization to form de-quantized forms 610a-610b for different target domains/environments 612a-612b (e.g., Chicago and Shanghai), respectively.

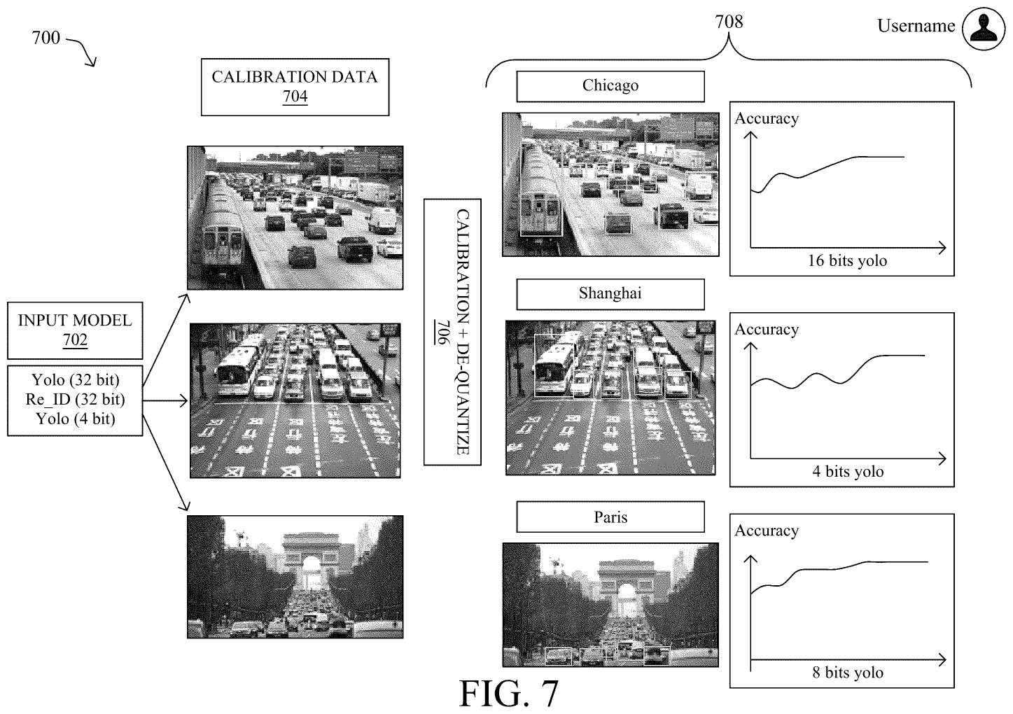

FIG. 7 illustrates an example user interface 700 for performing domain adaptation, in various implementations. As shown, user interface 700 may include an input 702 that allows the user to select a pre-trained model. For instance, such models may include a 32-bit You Only Look Once (YOLO) model, a 4-bit YOLO model, a 32-bit re-identification model, or the like.

In addition, 700 may also include an input 704 that allows the user to specify calibration data from the target domains/environments for which the resulting models are to be used. For instance, in some cases, the domain-adapted model may be deployed for execution by an edge device in the target domain/environment. Once the user has selected option 706 of user interface 700 to initiate the calibration and (de-) quantization, user interface 700 may then use the resulting domain-adapted models on the calibration data from the different target domains/environments and provide display data 708 for review, such as samples of the results of this analysis, indications of the accuracies of the domain-adapted models, or the like.

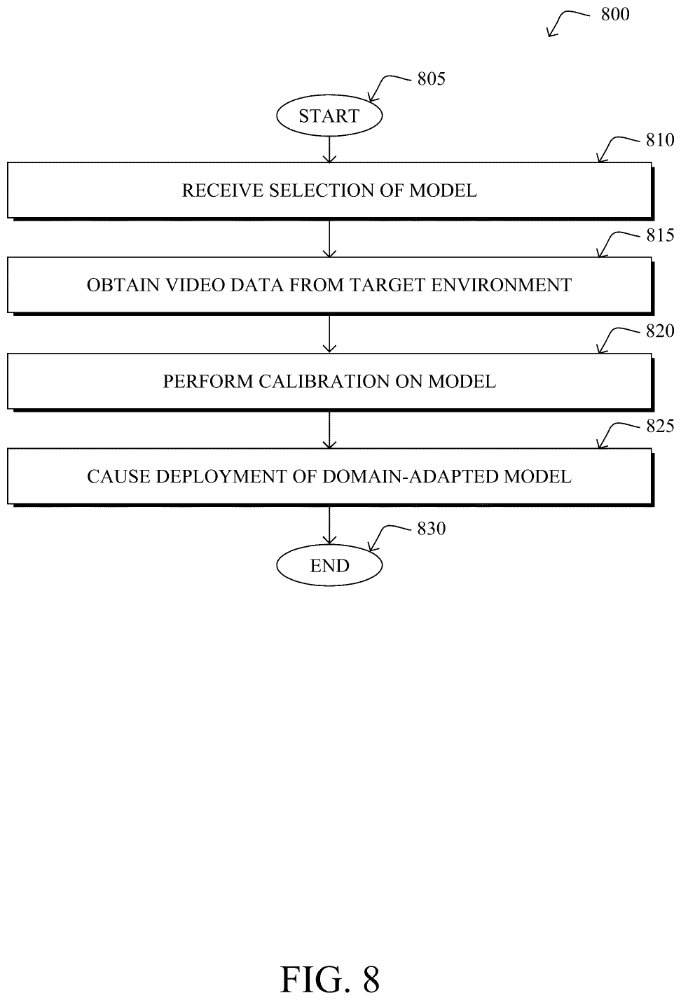

FIG. 8 illustrates an example simplified procedure 800 (e.g., a method) for domain adaptation via network calibration, in accordance with one or more implementations described herein. For example, a non-generic, specifically configured device (e.g., device 200), such as an edge device, a server, or other device in a network, may perform procedure 800 by executing stored instructions (e.g., domain adaptation process 248). The procedure 800 may start at step 805, and continues to step 810, where, as described in greater detail above, the device may receive, via a user interface, a selection of a machine learning model trained to perform a video analytics task using a training dataset. In various implementations, the video analytics task comprises at least one of: image classification, object re-identification, or object detection. In one implementation, the machine learning model is a You Only Look Once (YOLO) model.

At step 815, as detailed above, the device may obtain video data from a target environment that is not represented in the training dataset. In various implementations, the video data from the target environment that is not represented in the training dataset depicts a feature not depicted in the training dataset. In some implementations, the feature comprises at least one of: a camera angle, a lighting condition, a cosmetic style of a type of object, or an image background.

At step 820, the device may perform, using the video data, network calibration on the machine learning model to form a domain-adapted model, as described in greater detail above. In some implementations, the network calibration de-quantizes the machine learning model to form the domain-adapted model. In further cases, the device may perform the network calibration by determining an amount of distribution shift between the video data from the target environment and the training dataset. In one implementation, the device may perform the network calibration by computing a scaling factor and zero point for the network calibration based on the video data from the target environment.

At step 825, as detailed above, the device may cause the domain-adapted model to be deployed to perform the video analytics task with respect to the target environment. In some implementations, the device may do so by providing the domain-adapted model to an edge device in the target environment for execution. In some cases, the device may also compute an accuracy of the domain-adapted model and provide an indication of the accuracy of the domain-adapted model to the user interface.

Procedure 800 then ends at step 830.

It should be noted that while certain steps within procedure 800 may be optional as described above, the steps shown in FIG. 8 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for domain adaptation via network calibration, it is to be understood that various other adaptations and modifications may be made within the spirit and scope of the implementations herein. For example, while certain implementations are described herein with respect to specific use cases for the techniques herein, the techniques can be extended without undue experimentation to other use cases, as well.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof, that cause a device to perform the techniques herein. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method comprising:
receiving, at a device and via a user interface, a selection of a machine learning model trained to perform a video analytics task using a training dataset;
obtaining, by the device, video data from a target environment that is not represented in the training dataset;
performing, by the device and using the video data, network calibration on the machine learning model to form a domain-adapted model; and
causing, by the device, the domain-adapted model to be deployed to perform the video analytics task with respect to the target environment.

2. The method as in claim 1, wherein the video analytics task comprises at least one of: image classification, object re-identification, or object detection.

3. The method as in claim 1, wherein causing the domain-adapted model to be deployed to perform the video analytics task with respect to the target environment comprises:
providing the domain-adapted model to an edge device in the target environment for execution.

4. The method as in claim 1, wherein the network calibration de-quantizes the machine learning model to form the domain-adapted model.

5. The method as in claim 1, wherein the video data from the target environment that is not represented in the training dataset depicts a feature not depicted in the training dataset.

6. The method as in claim 5, wherein the feature comprises at least one of: a camera angle, a lighting condition, a cosmetic style of a type of object, or an image background.

7. The method as in claim 1, wherein performing network calibration on the machine learning model to form the domain-adapted model comprises:
determining an amount of distribution shift between the video data from the target environment and the training dataset.

8. The method as in claim 1, further comprising:
computing, by the device, an accuracy of the domain-adapted model; and
providing, by the device, an indication of the accuracy of the domain-adapted model to the user interface.

9. The method as in claim 1, wherein performing network calibration on the machine learning model to form the domain-adapted model comprises:
computing a scaling factor and zero point for the network calibration based on the video data from the target environment.

10. The method as in claim 1, wherein the machine learning model is a You Only Look Once (YOLO) model.

11. An apparatus, comprising:
a network interface to communicate with a computer network;
a processor coupled to the network interface and configured to execute one or more processes; and
a memory configured to store a process that is executed by the processor, the process when executed configured to:
receive, via a user interface, a selection of a machine learning model trained to perform a video analytics task using a training dataset;
obtain video data from a target environment that is not represented in the training dataset;
perform, using the video data, network calibration on the machine learning model to form a domain-adapted model; and
cause the domain-adapted model to be deployed to perform the video analytics task with respect to the target environment.

12. The apparatus as in claim 11, wherein the video analytics task comprises at least one of: image classification, object re-identification, or object detection.

13. The apparatus as in claim 11, wherein the apparatus causes the domain-adapted model to be deployed to perform the video analytics task with respect to the target environment by:
providing the domain-adapted model to an edge device in the target environment for execution.

14. The apparatus as in claim 11, wherein the network calibration de-quantizes the machine learning model to form the domain-adapted model.

15. The apparatus as in claim 11, wherein the video data from the target environment that is not represented in the training dataset depicts a feature not depicted in the training dataset.

16. The apparatus as in claim 15, wherein the feature comprises at least one of: a camera angle, a lighting condition, a cosmetic style of a type of object, or an image background.

17. The apparatus as in claim 11, wherein the apparatus performs network calibration on the machine learning model to form the domain-adapted model by:
determining an amount of distribution shift between the video data from the target environment and the training dataset.

18. The apparatus as in claim 11, wherein the process when executed is further configured to:
compute an accuracy of the domain-adapted model; and
provide an indication of the accuracy of the domain-adapted model to the user interface.

19. The apparatus as in claim 11, wherein the apparatus performs network calibration on the machine learning model to form the domain-adapted model by:
computing a scaling factor and zero point for the network calibration based on the video data from the target environment.

20. A tangible, non-transitory, computer-readable medium storing program instructions that cause a device to execute a process comprising:
receiving, at the device and via a user interface, a selection of a machine learning model trained to perform a video analytics task using a training dataset;
obtaining, by the device, video data from a target environment that is not represented in the training dataset;
performing, by the device and using the video data, network calibration on the machine learning model to form a domain-adapted model; and
causing, by the device, the domain-adapted model to be deployed to perform the video analytics task with respect to the target environment.
